(19) United States
(12) Patent Application Publication
(10) Pub. No.: US 2026/0225229 A1
(43) Pub. Date: Aug. 6, 2026

(54) WRISTED VINE ROBOT

(71) Applicant: The Regents of the University of California, Oakland, CA (US)

(72) Inventors: Elliot Wright Hawkes, Goleta, CA (US); Tania K. Morimoto, San Diego, CA (US); Cedric Girerd, Artemare (FR)

(21) Appl. No.: 19/159,903

(22) PCT Filed: Mar. 11, 2024
(86) PCT No.: PCT/US2024/019432

§ 371 Date: Aug. 26, 2025

Related U.S. Application Data
(60) Provisional application No. 63/490,822, filed on Mar. 17, 2023.

(51) Int. Cl. B25J 9/10; B25J 9/06; B25J 9/14; F15B 15/10

(52) U.S. Cl. CPC B25J 9/1075; B25J 9/065; B25J 9/14; F15B 15/103

(57) ABSTRACT

A soft vine robot has a main body configured as a tube inverted back inside itself to define a pressure channel, such that when the channel is pressurized, the main body everts, and inverted material everts and passes out of a tip at a distal end of the main body. A steering tube is held by and extends with the main body. A wrist joint is defined by a portion of the steering tube. A tendon extends along the steering tube and is fixedly attached to the steering tube distally of the wrist joint such that pulling tension applied to the tendon induces bending of the steering tube and the main body at the wrist joint.

### PRIORITY CLAIM AND REFERENCE TO RELATED APPLICATION

The application claims priority under 35 U.S.C. § 119 and all applicable statutes and treaties from prior U.S. provisional application Ser. No. 63/490,822, which was filed Mar. 17, 2023.

### STATEMENT OF GOVERNMENT INTEREST

This invention was made with government support under 1944816 awarded by National Science Foundation. The government has certain rights in this invention.

### FIELD

A field of the invention is robotics, and particularly vine robots, which are everting soft robots. A preferred specific application is to millimeter scale diameter vine robots.

### BACKGROUND

Regular vine growing robots are typically made of a thin plastic or fabric tube which is partially everted. The layer of material located in the outside is called the body, and the part that is everted inside it is called the tail. By pressurizing the vine, its tail translates along its body and everts at the tip. This enables vine robots to locomote by growth at the tip instead of deploying with a rigid body translation with respect to the environment.

These robots expand by fluid pressure and can adopt a predefined shape which leads to a maximum volume when pressurized, or can be shaped by a surrounding environment that provides rigid resistance. The shape of vine robots has also been controlled in previous robots by introducing curvatures that enable these robots to passively or actively make turns. Active control mechanisms include latches, tendons, sPAMs and IPAMs. sPAMs and IPAMs are arrays of external pneumatic chambers that are used as actuators. In the context of the vine robot, they are placed around the vine body to bend it. See, Greer et al, “A Soft, Steerable Continuum Robot That Grows via Tip Extension,” Soft Robot. 6 (1):95-108 (2019).

In prior vine robots with tendons, the tendons are routed around the vine body. See, e.g., Blumenschein et al., “Helical Actuation on a Soft Inflated Robot Body,” 2018 IEEE International Conference on Soft Robotics (Apr. 24-28 2018); Blumenschein et al., “A Tip-Extending Soft Robot Enables Reconfigurable and Deployable Antennas,” IEEE Robotics and Automation Letters Vol 3, No. 2(2018 ); Gan et al., “3D Electromagnetic Reconfiguration Enabled by Soft Continuum Robots,” IEEE Robotics and Automation Letters Vol. 5, No. 2(2020 ); Wang et al., “A Dexterous Tip-extending Robot with Variable-length Shape-locking”, IEEE International Conference on Robotics and Automation (2020).

These previous approaches have been limited to vines of centimeters of diameters in order of magnitude. The size of mechanisms required to modify the curvature limits the downward scalability of these vine robots. For example, the prior tendon design is limited to larger diameters because the tendons are routed around the vine body and typically require separate guide tubes to guide the tendons around the vine body. Friction between the tendons and the vine body or tendon guides with these types of robots also makes it likely that smaller than several centimeter scaled vines would buckle when the tendons are translated.

A prior tip-everting robot included motion control with a tendon-actuated wrist located inside the tail material. The vine robot relied upon a separate tendon-driven robotic steering catheter in the inner channel. The steering catheter consisted of flexible NiTi tube, a stainless-steel proximal tube (semi-flexible) and 4-strands of tendon. The NiTi tube included patterned notches on the side, allowing it to bend in a specific direction as the tendon is pulled. However, the wrist could not be translated without depressurizing the vine, since the tail material blocks it due to the internal vine robot pressure. Operation is slowed because growth requires a repeated cycle of steps include multiple depressurization steps and re-pressurization steps. The metal steering catheter also adds rigidity. See Berthet-Rayne, “MAMMOBOT: A Miniature Steerable Soft Growing Robot for Early Breast Cancer Detection,” in IEEE Robotics and Automation Letters, vol. 6, no. 3, pp. 5056-5063, July 2021. Another disadvantage the wrist moves forward with the tail, changing the location of the bend with respect to the anatomy. This can lead to paths or branches to be missed during deployment because it is not possible to set a bend position and then continue growth after the bend positioned.

### SUMMARY OF THE INVENTION

A preferred embodiment provides a soft vine robot that has a main body configured as a tube inverted back inside itself to define a pressure channel, such that when the channel is pressurized, the main body everts, and inverted material everts and passes out of a tip at a distal end of the main body. A steering tube is held by and extends with the main body. A wrist joint is defined by a portion of the steering tube. A tendon extends along the steering tube and is fixedly attached to the steering tube distally of the wrist joint such that pulling tension applied to the tendon induces bending of the steering tube and the main body at the wrist joint.

### BRIEF DESCRIPTION OF THE DRAWINGS

FIGS. 1A and 1B a partial schematic views of a preferred soft vine robot with a wrist joint in respective bent and straight positions;

FIG. 1C shows a variation of the FIGS. 1A and 1B soft vine robot with a steering tube that extends to the tip of the robot;

FIGS. 2A and 2B are images of a prototype wristed vine robot consistent with FIGS. 1A and 1B in an everted straight position (FIG. 2A) and a bent wristed position (FIG. 2B);

FIG. 3 is a series of images showing a prototype wristed vine robot consistent with FIGS. 1A and 1B as it everts and bends;

FIG. 4 is a series of images showing a prototype wristed vine robot consistent with FIGS. 1A and 1B as it everts and bends to avoid obstacles;

FIG. 5 is a partial schematic view of a preferred soft vine robot with a wrist joint formed by notches;

FIG. 6 is a partial schematic view of a preferred soft vine robot with a plurality of wrist joints with one being formed in accordance with FIGS. 1A and 1B and another being formed in accordance with FIG. 5; and

FIGS. 7A and 7B are partial schematic views of a preferred soft vine robot with a wrist joint and a tendon tube in respective bent and straight positions.

### DESCRIPTION OF THE PREFERRED EMBODIMENTS

Preferred embodiments provide a vine robotic device with a steering tube and a tendon-actuated wrist. The tendon is integrated into the steering tube located inside the vine. The tendon extends inside the steering tube and can remain inside the steering tube or exit the steering tube through its wall before it reaches a distal portion of the steering tube. The tendon extends along an external or internal wall of the steering tube and is fixedly attached to a distal portion of the steering tube, e.g. a distal tip of the steering tube. In preferred robots of the invention, the wrist can be integrated at the base of the tail and can be pushed to the very tip of the vine, thus scrunching the tail material, or can be integrated on the side of the tail.

Material of the steering tube must be stiff enough so that it can be pushed from its proximal base distally into the main body of the robot. Plastic and multilayer plastic tubes typically used for catheters are suitable to use for material of the steering tube. Such tubes can have metal reinforcement that provides a higher torsional stiffness. Metal or alloy tubes, such as made of Nitinol can be used but are less preferred than plastic tubes and should be avoided in some applications, such as invasive applications in body lumens. Metal steering tubes also don't perform well when passing multiple curves, showing a tendency to straighten the robot body where a curve is desired. A preferred plastic that has been used on prototype steering tubes in prototype robots is thermoplastic polyurethane (TPU).

Options for creating curvature via a wrist joint include having one or more exit points where the tendon exits and/or re-enters the steering tube, and/or one or more notches on the steering tube. Multiple wrist joints can provide a gradual curve instead of a sharp angle curve. Similarly, multiple tendons each reaching parts of the steering tube that have notches can provide multiple wrist joints at desired locations and orientations (axial locations and circumferential orientations). The point(s) of curvature effectively form one or more wrists, a robot portion that can be bent in a wrist-like fashion. Pulling on the tendon at its proximal end applies force to the point of fixed attachment of the tendon to the steering tube and bends the steering tube at the point(s) of curvature, which also bends the vine body at this location. Translating and rotating the steering tube and actuating the wrist enables curvatures to be formed along the vine in desired locations and orientations, with a desired angle.

While previous steering and bending mechanisms are suitable for vine robots of several centimeters of diameters, actively modifying the shape of millimeter-scale vine robots with such mechanisms is difficult. The present invention provides a bending approach that can be used in both millimeter, centimeter and larger diameter-scaled vine robots. The integration of a steering tube and tending-actuated wrist joint provides a very scalable solution with a minimalized mechanical profile and is easily located inside even very small-scale vine robots to provide an active bending mechanism.

Preferred embodiment vine robots can also include features provided by prior vine robots. Example includes features useful for fluid emission, as disclosed in Hawkes & Naclerio WO 2020/060858, entitled Soft Robotic Device with Fluid Emission for Burrowing and Cleaning. The fluidization tube can be a separate tube within a steering tube of the present robots. The reeling and steering control features of Haggerty and Hawkes WO 2022/192190, entitled Active Reeling and Steering Control of a Vine Robot, can also be incorporated into preferred embodiments, where the reeling and steering control features would be between the distal tip of the main body and a distal tip of the steering tube, or if the reeling and steering device can translate through the steering tube or another tube in within the steering tube. As another example, portions of a robot of the invention could include active control of the relative lengths of wall material along opposing sides of the body as disclosed in Hawkes et al., US Published Application number 20190217908, entitled Robotic Mobility and Construction by Growth.

Preferred embodiments of the invention will now be discussed with respect to experiments and drawings. Broader aspects of the invention will be understood by artisans in view of the general knowledge in the art and the description of the experiments that follows.

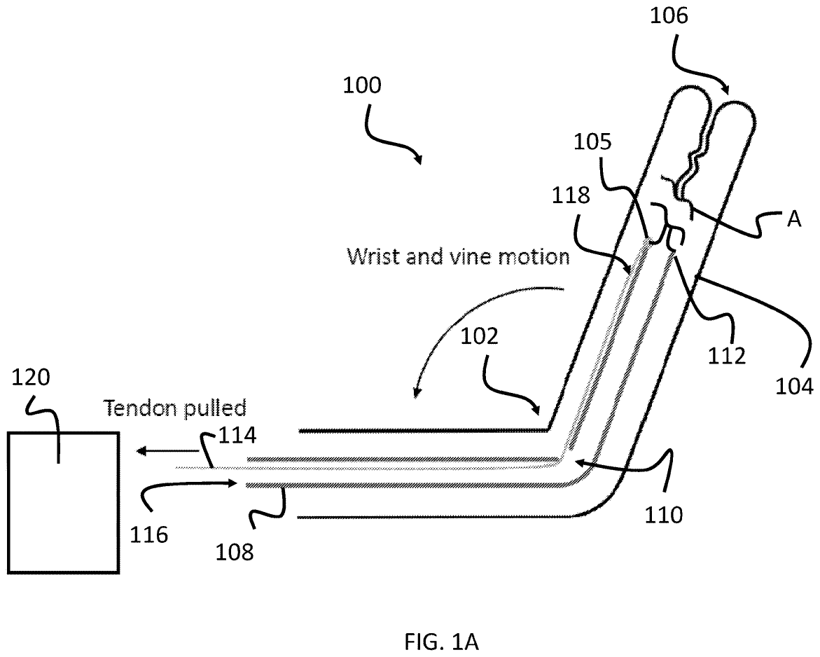

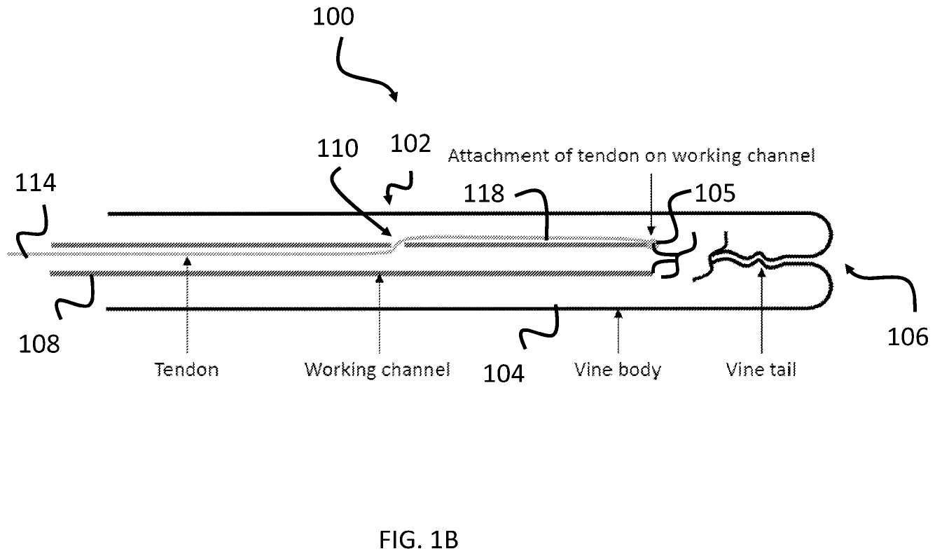

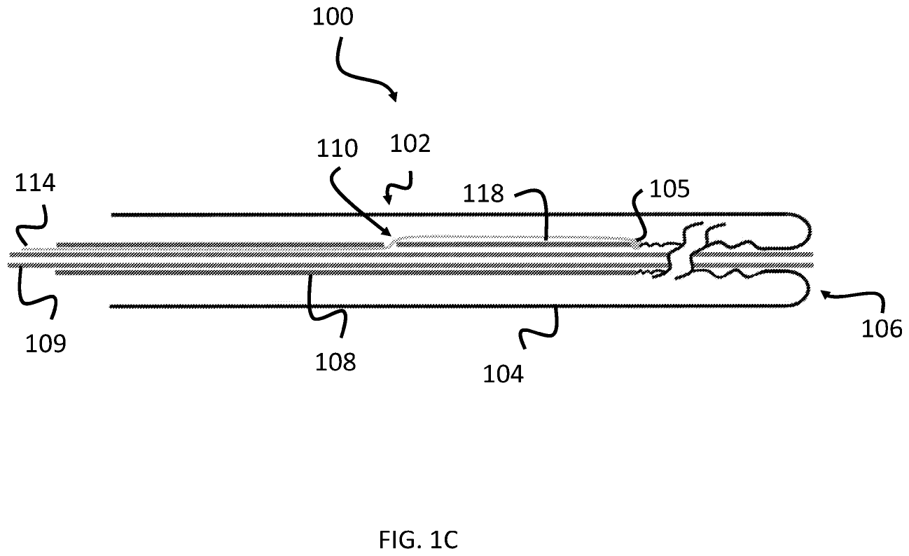

FIGS. 1A and 1B show a soft vine robot 100 with a wrist joint 102 in respective bent and straight positions. The soft vine robot 100 includes a main body 104 configured as a tube inverted back inside itself to define a pressure channel, such that when the channel is pressurized via fluid pressure, the main body everts, and inverted material everts and passes out of a tip at a distal end 106 of the main body. A steering tube 108 is within the main body. FIGS. 1A and 1B are partial schematic views, with a broken line A indicating additional length of the main body 104/steering tube 108, which can both extend well beyond the relative dimensions shown in FIGS. 1A and 1B.

An exit opening 110 defines a wrist joint in the steering tube 108, the exit opening 110 being located between a distal end 112 and proximal end 116 of the steering tube 108. While one exit opening 110 is shown, there can be multiple exit openings at different axial and/or circumferential locations of the steering tube 108. The exit opening(s) defines the wrist joint(s) 102. A tendon 114 enters the steering tube 108 at its proximal end 116, extends through the exit opening 110, runs along an outer portion 118 of the steering tube 108 inside the main body 104 and is fixedly attached at an attachment point 105 to the steering tube 108 distally of the exit opening 110 (either inside or outside of the steering tube 108). With additional exit openings, the tendon (or multiple tendons) can re-enter the steering tube 108 to define another wrist joint and can be fixedly attached within the steering tube 108.

In FIGS. 1A and 1B, the fixed attachment point is at the distal end 112 of the steering tube 108, but the point of attachment need only be distal of the wrist joint 102, and as mentioned above can be alternatively to an inner wall of the steering tube 108 when the tendon 114 remains within or re-enters the steering tube 108. Pulling tension applied to tendon 114 pulls any portion of the steering tube 108 and the main body 104 distal of the wrist joint 102 back toward portions proximal of the wrist joint 102. Tension can be applied by a mechanically controlled device, that can include a controller 120 that also provides fluid pressure via a pump to evert the main body 104.

The main body 104 can have centimeter-scale or larger diameters, but can also have smaller diameter, including millimeter-scale diameters, e.g., less than 10 millimeters, and can be equal to or less than 5 millimeters, e.g. approximately 2.5 mm, 1 mm or 0.5 mm.

While one wrist joint 102 is shown in FIGS. 1A and 1B, a vine robot of the invention can have more wrist joints with openings and fixed connections distributed axially and/or radially along the steering tube 108 to provide complex bending movements and can each be independently activated when connected to an independent tendon.

FIG. 1C shows the vine robot 100 of FIGS. 1A and 1B with a longer working tube 109 within a steering tube 108. The working tube 109 in FIG. 1C extends the entire length of the body 104 and provides the working tube 109 access to the tip at the distal end 106. This is useful, for example, to deliver tools, cameras, fluids, sensors, etc. to the distal end 106 of the vine robot 100. The working tube 109 in FIG. 1C can also be used to apply suction, which can be controlled by the controller 120. The working tube 109 is partially contained within a lumen of the steering tube 108, and continues distally beyond the steering tube 108. The steering tube 108 is more rigid than the working tube 108 and is not coupled to the working tube. After actuation, the steering tube 108 can remain stationary while inserting and the working tube 109.

In FIGS. 1A-1C, the steering tube 108 can be attached to the robot body 104 at various points or along the entire length of the steering tube 108. It can also be unattached to the body 104 along its entire length or at portions of its length. When unattached, pressure will pull on the loose material stored inside the robot body For example, the robot body 104 can be steered with the steering tube 108 as the body 104 everts and grows up to a point to avoid obstacles and then the steering tube 108 can be retracted to allow larger diameter growth of the robot body 104 for all portions of the robot body 104 that are not attached to the steering tube 108. This includes portions of the both 104 that are distally aligned with the steering tube 108 as well as portions beyond the steering tube 108. After a separate working tube 109 is inserted as in FIG. 1C, body material 104 distal to the working tube 109 cannot deploy further if the working tube 109 remains stationary with respect to the environment. Initially loose body material is pulled from the tip with the internal vine robot pressure, and will become straight and tensioned. The robot can continue to grow by pushing the working tube 109 forward, enabling stored material of the body 104 to move forward with the working tube 109.

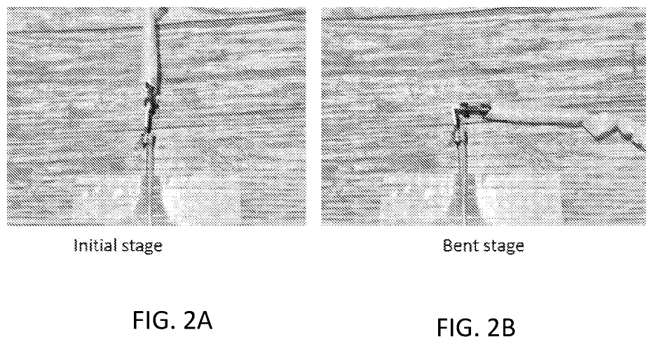

FIGS. 2A and 2B show a prototype wristed vine robot in an everted straight position (FIG. 2A) and a bent wristed position (FIG. 2B). The bent wristed position is achieved by applying pull force to its tendon to cause the over 90-degree bend at its wrist joint. The amount that the tendon is pulled back determines the amount of bend at the wrist joint. A large range of angles at the wrist joint can be readily achieved with control of the amount of retraction of the tendon.

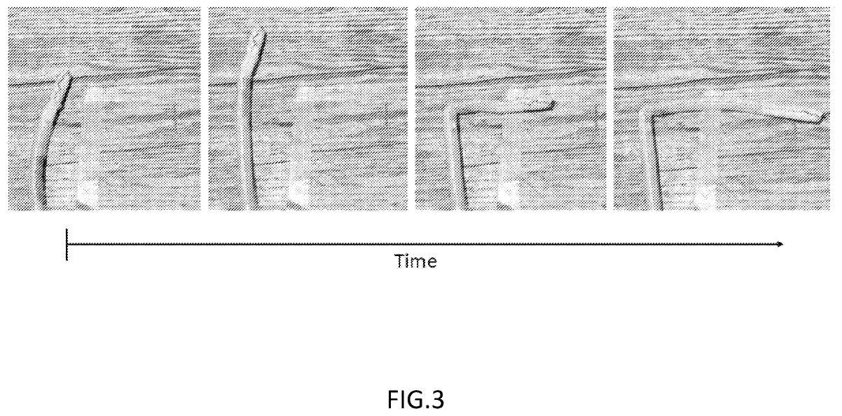

FIG. 3 is a series of still frames showing a prototype wristed vine robot as it everts and bends. In the first frame, it is partially extended without activation of the tendon, in the second frame, it is more extended and the wrist joint is activated by pulling on the tendon, which continues to produce an approximate 90-degree bend, and the last frame shows continued extension/eversion while the tension is maintained on the tendon to maintain the bending of the wrist joint.

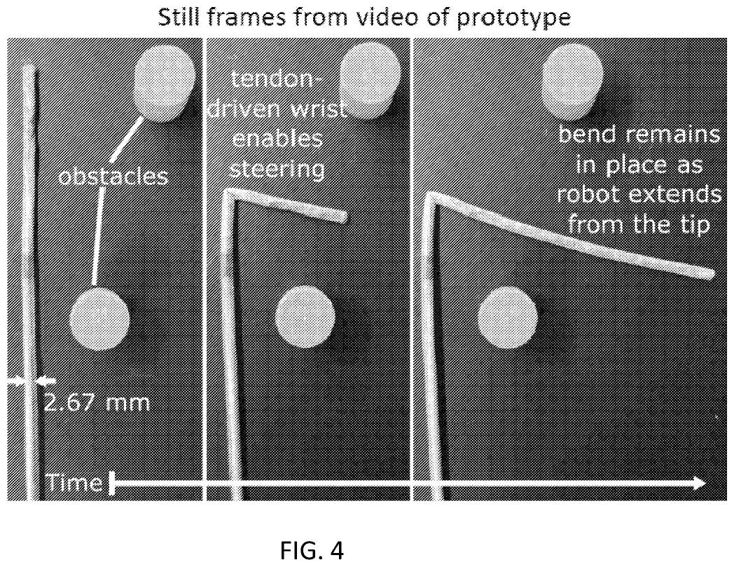

FIG. 4 is another series of still frames showing a prototype wristed vine robot having a 2.67 mm diameter as it everts and bends to avoid a pair of obstacles. The robot can include sensors/cameras that can be used by its control system to navigate an environment. Cameras and sensors can be located along different parts of the main body to provide information to a controller as the robot grows and extends into its environment. The second and third frames illustrate that the tendon and wrist joint can achieve more than a 90-degree bend at the wrist joint and that extension/eversion can continue. The tendon and wrist joint can be realized with even smaller diameters of main body, e.g., a 1 mm diameter and even sub-millimeter diameters, e.g., 0.5 mm.

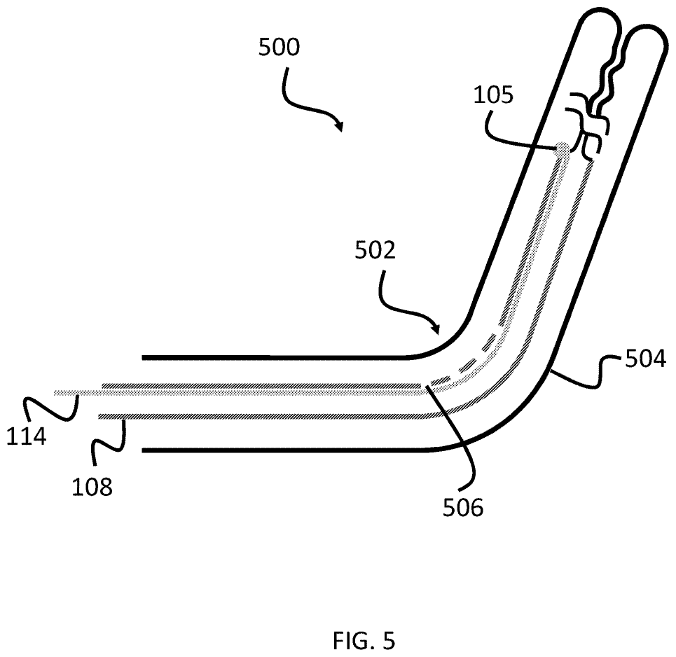

FIG. 5 shows another preferred vine robot 500 with a wrist joint 502 in its main body 504 formed by a plurality of notches 506 in the steering tube 108. The notches 506 are preferably a series of small openings/gaps in material. The notches 506 can also be series of thinned areas of material. Gaps of missing material are preferred as allowing material between notches to get closer, and the space is restored as the working tube straightens back to its original shape. Thinned areas provided comparably less bending ability and have more of a tendency to kink without being able to fully restore a straight shape. The notches 506 can also be areas of smaller diameter or areas of lesser cross-sectional stiffness in the steering tube 108. The robot 500 includes a tendon 114 that remains within the steering tube 108 and is attached to the steering tube 108 distally of the wrist joint 502 at the attachment point 105. A set of several notches 506 provides a gradual, continuous bending shape to control curvature at the wrist joint 502 when pulling tension is applied to the tendon 114. Pulling on the tendon 114 will cause bending in the direction where the steering tube is the weakest, which is the wrist joint area including the plurality of notches 506, More notches can provide more gradual curvature and fewer can provide a sharper curve at the wrist joint(s) 502. Multiple sets of notches at different axial and circumferential positions can be used with multiple tendons to provide complex curvature patterns via multiple wrist joints.

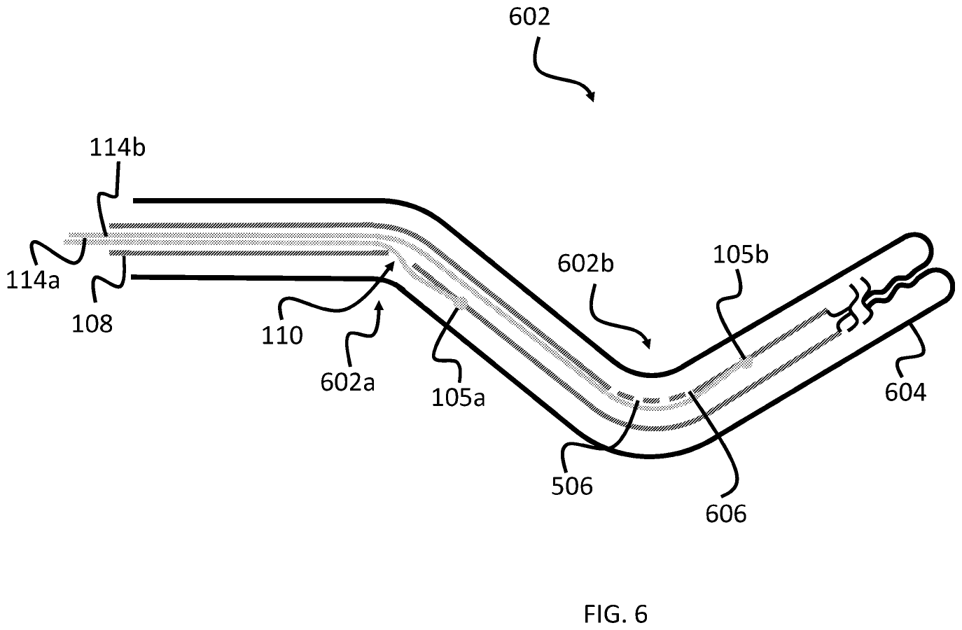

FIG. 6 shows another preferred vine robot 600 with two wrist joints 602a and 602b in its main body 604. The wrist joint 602a is formed in accordance with the wrist joint 102 in FIGS. 1A and 1B and bending control is through tension applied to a tendon 114a. The wrist joint 602b is formed in accordance with the wrist joint 502 in FIG. 5 and bending control is through tension applied to a tendon 114b. The multiple wrist joints 602a and 602b are independently activated/controlled by tension applied to the tendons 114a and 114b to causing bending the two wrist joints 602a and 602b. The points of attachment 105a and 105b (as well as the exit opening 110 and notches 506) and can be at different radial positions on the steering tube 108. Using multiple radial position creates the ability to have non-parallel axes of bending for the wrists 602a and 602b. With many wrists, the robot can then turn in different directions at each wrist to navigate around a complex set of obstacles in three-dimensional space.

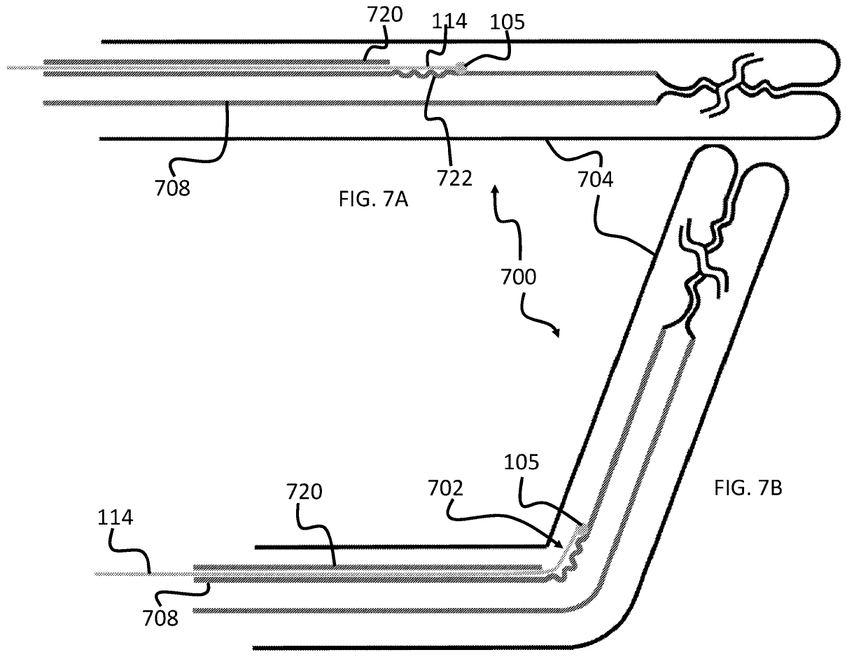

FIGS. 7A and 7B show a preferred soft vine robot 700 with a tendon tube 720 that is external to a steering tube 708. Using the separate tendon tube 720 (or multiple separate tendon tubes at different circumferential positions to have multiple wrist joints that have non-parallel axes of bending) permits the steering tube 708 to be sealed along its length to its terminal end. In this configuration, the steering tube 708 works also as a working tube, and can deliver fluid or tools to a distal end of a main body 704 of the robot 700. A wrist joint 702 is defined by a softened or crinkled portion 722 of the steering tube 708. The tendon 114 extends within a lumen of the tendon tube 720 and is attached at attachment point 105 distally of the wrist joint 702. The tendon tube terminates proximally of the wrist joint 702 in the robot 700, but it can also extend past the wrist when the tendon tube is flexible enough over its length or at the wrist joint 702 to permit the wrist joint 702 to bend.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A soft vine robot, comprising:
a main body configured as a tube inverted back inside itself to define a pressure channel, such that when the channel is pressurized, the main body everts, and inverted material everts and passes out of a tip at a distal end of the main body;
a steering tube held by and extending with the main body;
a wrist joint defined by a portion of the steering tube; and
a tendon extending along the steering tube, the tendon being fixedly attached to the steering tube distally of the wrist joint such that pulling tension applied to the tendon induces bending of the steering tube and the main body at the wrist joint.

2. The soft vine robot of claim 1, wherein the wrist joint comprises an exit opening in the steering tube and the tendon extends from inside a lumen of the steering tube through the exit opening.

3. The soft vine robot of claim 1, wherein the wrist joint comprises a plurality of notches in the steering tube.

4. The soft vine robot of claim 3, wherein the notches comprise gaps of missing material.

5. The soft vine robot of claim 1, wherein the notches comprise thinned areas of material, areas of smaller diameter or areas of lesser cross-sectional stiffness.

6. The soft vine robot of claim 1, wherein the tendon extends within a lumen of the steering tube.

7. The soft vine robot of claim 1, comprising a tendon tube external to the steering tube, wherein the tendon extends through a lumen of the tendon tube.

8. The soft vine robot of claim 7, wherein the steering tube is sealed along its length to its terminal end.

9. The soft vine robot of claim 1, comprising a plurality of wrist joints defined by a plurality of portions of the steering tube.

10. The soft vine robot of claim 9, wherein one of the plurality of wrist joints comprises an exit opening in the steering tube and the tendon extends from inside a lumen of the steering tube through the exit opening and another one of the plurality of wrist joints comprises plurality of notches in the steering tube with another tendon that extends within the lumen of the steering tube.

11. The soft vine robot of claim 10, wherein the notches comprise gaps of missing material.

12. The soft vine robot of claim 10, wherein the notches comprise thinned areas of material, areas of smaller diameter or areas of lesser cross-sectional stiffness.

13. The soft vine robot of claim 9, wherein plurality of wrist joints comprise non-parallel axes of bending.

14. The soft vine robot of claim 1, comprising
control and communications electronics to control a pump for eversion of the main body and to control tension on the tendon.

15. The soft vine robot of claim 1, comprising a working tube at least partially within a lumen of the steering tube.

16. The soft vine robot of claim 15, wherein the working tube is uncoupled from the steering tube.

17. The soft vine robot of claim 16, wherein the working tube extends along an entire length of the main body and provides access to a distal end of the main body through the working tube.

18. The soft vine robot of any previous claim 1, wherein the steering tube is attached to the main body at various points or along an entire length of the steering tube.

19. The soft vine robot of claim 1, wherein the steering tube is unattached to the main body along at least a portion of the steering tube.

20. The soft robot of claim 1, wherein the main body has millimeter to centimeter-scale diameter.

21-24. (canceled)
